(19) United States
(12) Patent Application Publication
(10) Pub. No.: US 2017/0161583 A1
(43) Pub. Date: Jun. 8, 2017

(54) TESTING DEVICE AND METHOD THEREOF

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Xiubao ZHANG, Tianjin (CN)

(21) Appl. No.: 15/249,859

(22) Filed: Aug. 29, 2016

Related U.S. Application Data
(63) Continuation of application No. PCT/CN2016/089350, filed on Jul. 8, 2016.

(30) Foreign Application Priority Data
Dec. 3, 2015 (CN) 201510883622.8

(51) Int. Cl. G06K 9/46

(52) U.S. Cl. CPC G06K 9/4652

(57) ABSTRACT

An embodiment of the present disclosure discloses a testing device and a method thereof, wherein the method specifically includes: determining the number of chromatic dispersion pixel points in a target image; wherein the target image is an image generated after being output onto a screen by a preset preprocessing algorithm and passing through a lens, and the preset preprocessing algorithm is used for performing preprocessing on an image in a virtual reality helmet; determining a ratio of the chromatic dispersion pixel points to total pixel points of the target image according to the number of the chromatic dispersion pixel points; and determining a chromatic dispersion degree of the target image according to the ratio. The embodiment of the present disclosure may realize the testing of a preprocessing result of the preprocessing algorithm.

### CROSS-REFERENCE TO RELATED APPLICATIONS

The present disclosure is a continuation of International Application No. PCT/CN2016/089350 filed on Jul. 8, 2016, which is based upon and claims priority to Chinese Patent Application No. 201510883622.8, entitled “TESTING DEVICE AND METHOD THEREOF”, filed on Dec. 3, 2015, the entire contents of all of which are incorporated herein by reference.

### TECHNICAL FIELD

The present disclosure generally relates to the field of information technology, and particularly relates to a testing device and a method thereof.

### BACKGROUND

The VR (virtual reality) helmet was the earliest form of virtual reality display, which may induce the user to have a feeling of being inside a virtual environment by blocking the user's visual and audio senses with respect to the external environment using the helmet display. As a piece of virtual reality display equipment, the helmet display is characterized in small size and high closeness and is widely used in projects like military training, virtual driving, virtual city, etc.

The display principle of the VR helmet is: left-eye and right-eye screens display differential images respectively for left and right eyes, so that a stereoscopic sense is produced in the brain after human eyes obtain such differential information. During the process of achieving the present disclosure, the inventor found that: since a screen lens has different refractive indexes with respect to different wave lengths, chromatic dispersion occurs to the image generated after passing through the screen lens, and therefore the image quality observed by human eyes is degraded and the user's visual experience is impacted, so it is desirable to design an algorithm and do preprocessing on the VR image output by the VR helmet and the image before passing through the screen lens by means of software, thereby reducing chromatic dispersion error of the image caused by the lens and improving the user's experience.

There are currently multiple preprocessing algorithms, but hardly any of these preprocessing algorithms may eliminate chromatic dispersion in a way that is 100 percent successful, and therefore a testing method is desired to test the result of preprocessing performed by the above various preprocessing algorithms on the VR image in order to compare advantages and disadvantages of the above various algorithms.

### SUMMARY

An embodiment of the present disclosure discloses a testing device and a method thereof for solving the shortcoming that current methods cannot obtain the result of preprocessing performed by the preprocessing algorithm on the VR image, in order to realize testing on the preprocessing result of the processing algorithm.

According to an embodiment of the present disclosure, there is provided a testing method, at an electronic device, including:

determining the number of chromatic dispersion pixel points in a target image; wherein the target image is an image generated after being output onto a screen by a preset preprocessing algorithm and passing through a lens, and the preset preprocessing algorithm is used for performing preprocessing on an image in a virtual reality helmet;

determining a ratio of the chromatic dispersion pixel points to total pixel points of the target image according to the number of the chromatic dispersion pixel points; and

determining a chromatic dispersion degree of the target image according to the ratio.

According to an embodiment of the present disclosure, there is provided an electronic device, including:

at least one processor; and a memory communicably connected with the at least one processor for storing instructions executable by the at least one processor, wherein execution of the instructions by the at least one processor causes the at least one processor to:

determine the number of chromatic dispersion pixel points in a target image; wherein the target image is an image generated after being output onto a screen by a preset preprocessing algorithm and passing through a lens, and the preset preprocessing algorithm is used for performing preprocessing on an image in a virtual reality helmet;

determine a ratio of the chromatic dispersion pixel points to total pixel points of the target image according to the number of the chromatic dispersion pixel points; and

determine a chromatic dispersion degree of the target image according to the ratio.

According to an embodiment of the present disclosure, there is provided a computer program, including a computer readable code, wherein when the computer readable code is run on an electronic device, it causes the electronic device to execute any one of the testing methods above.

According to an embodiment of the present disclosure, there is provided a non-transitory computer readable medium storing executable instructions that, when executed by an electronic device, cause the electronic device to: determine the number of chromatic dispersion pixel points in a target image; wherein the target image is an image generated after being output onto a screen by a preset preprocessing algorithm and passing through a lens, and the preset preprocessing algorithm is used for performing preprocessing on an image in a virtual reality helmet; determine a ratio of the chromatic dispersion pixel points to total pixel points of the target image according to the number of the chromatic dispersion pixel points; and determine a chromatic dispersion degree of the target image according to the ratio.

In view of the foregoing, the testing device and the method thereof disclosed by the embodiment of the present disclosure may determine the chromatic dispersion degree of a target image according to a ratio of chromatic dispersion pixel points to total pixel points of the target image, and since the chromatic dispersion pixel points are caused by chromatic dispersion, it may be considered that the greater the ratio of chromatic dispersion pixel points is, the higher the chromatic dispersion degree of the target image will be, and thus the less ideal the preset preprocessing algorithm is; on the contrary, the smaller the ratio of chromatic dispersion pixel points is, the lower the chromatic dispersion degree of the target image will be, and thus the more ideal the preset preprocessing algorithm is; therefore the embodiment of the present disclosure may accordingly test the chromatic dispersion degree of the image generated after passing through the screen lens and the advantages and disadvantages of the preset preprocessing algorithm, i.e., may realize the testing of the preprocessing result of the preprocessing algorithm.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a step flowchart of a testing method according to a first embodiment of the present disclosure.

FIG. 2 is a step flowchart of a testing method according to a second embodiment of the present disclosure.

FIG. 3 is a schematic view of a black-and-white checkerboard image generated after being preprocessed by a preset preprocessing algorithm and passing through a screen lens in a virtual reality helmet of the present disclosure.

FIG. 4 is a schematic structural diagram of a testing device according to a first embodiment of the present disclosure.

FIG. 5 is a schematic structural diagram of a testing device according to a second embodiment of the present disclosure.

FIG. 6 is a schematic structural diagram of a testing device according to a third embodiment of the present disclosure.

FIG. 7 schematically shows a block diagram of an electronic device for executing the method according to the present disclosure.

FIG. 8 schematically shows a storage unit for retaining or carrying a program code for achieving the method according to the present disclosure.

### DETAILED DESCRIPTION

For the purpose of making objects, technical schemes and advantages of an embodiment of the present disclosure more clear, a clear and complete description will be made of technical schemes of the present disclosure in conjunction with corresponding drawings in the embodiment of the present disclosure. Obviously, the described embodiments are merely a part of the embodiments of the present disclosure and not all the embodiments. Based on the embodiments of the present disclosure, all other embodiments obtained by a person skilled in the art without paying creative work fall within the protection scope of the present disclosure.

### Embodiment I

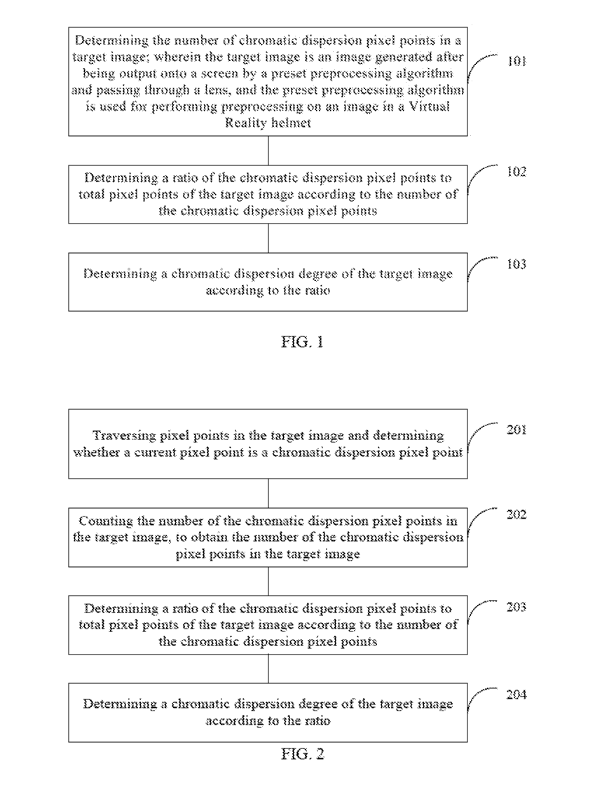

With reference to FIG. 1, it shows a step flowchart of a testing method according to a first embodiment of the present disclosure, which may specifically include steps as follows.

Step 101, determining the number of chromatic dispersion pixel points in a target image; wherein the target image is an image generated after being output onto a screen by a preset preprocessing algorithm and passing through a lens, and the preset preprocessing algorithm is used for performing preprocessing on an image of a virtual reality helmet.

The embodiment of the present disclosure may be applied to the field of VR technology, to test the chromatic dispersion degree of the image which is output by the VR helmet through the preset preprocessing algorithm and passes through the screen lens, and the specific process may include that: the VR helmet generates a virtual VR image, and then performs corresponding processing on the VR image using the preset preprocessing algorithm and then outputs it to the screen lens, and the image passing through the screen lens becomes a target image which may be obtained by the user, and the embodiment of the present disclosure is to test the chromatic dispersion degree of the above described target image.

In the embodiment of the present disclosure, the above described preset preprocessing algorithm, in particular, may be an algorithm designed according to factors such as screen size, resolution, relative parameters of the screen lens and used for eliminating or compensating chromatic dispersion, for example, pulsar de-dispersion algorithm, coherent de-dispersion algorithm, optical fiber polarization mode dispersion compensation algorithm and the like, and the embodiment of the present disclosure does not particularly limit the above described preset preprocessing algorithm.

In the embodiment of the present disclosure, the above described chromatic dispersion pixel points, in particular, may be pixel points that are differentiated in color from pixel points in the target image in an ideal state without chromatic dispersion, for example, the target image is a black-and-white checkerboard image, and in the ideal state without chromatic dispersion, the color of pixel points in the target image includes black and white; and those pixel points differentiated from the above two colors are chromatic dispersion pixel points, wherein the color differentiated from the above described black and white colors may include: red, orange, pink, green, blue, violet, yellow and so on.

Step 102, determining a ratio of the chromatic dispersion pixel points to total pixel points of the target image according to the number of the chromatic dispersion pixel points.

In the embodiment of the present disclosure, the ratio of the chromatic pixel points to the total pixel points of the target image may be determined using the following equation (1):

$$P = \frac{C}{W \times H} \times 100 \% \qquad ( 1 )$$

Where the above P may represent the ratio of the chromatic dispersion pixel points to the total pixel points of the target image; the above C may represent the number of chromatic dispersion pixel points; the W may represent the width of the target image; the H may represent the height of the target image; and the W×H may represent the total pixel points of the target image.

Step 103, determining a chromatic dispersion degree of the target image according to the ratio.

In the embodiment of the present disclosure, when the ratio of the chromatic dispersion pixel points to the total pixel points of the target image is smaller, it may be determined that the chromatic dispersion degree of the target image is lower, when the ratio of the chromatic dispersion pixel points to the total pixel points of the target image is greater, it may be determined that the chromatic dispersion degree of the target image is higher.

In view of the foregoing, in the embodiment of the present disclosure, the chromatic dispersion degree of the target image may be determined according to the ratio of chromatic dispersion pixel points to total pixel points of the target image, and since the chromatic dispersion pixel points are caused by chromatic dispersion, it may be considered that the larger the ratio of chromatic dispersion pixel points is, the higher the chromatic dispersion degree of the target image will be, and thus the less ideal the preset preprocessing algorithm is; on the contrary, the smaller the ratio of chromatic dispersion pixel points is, the lower the chromatic dispersion degree of the target image will be, and thus the more ideal the preset preprocessing algorithm is; therefore the embodiment of the present disclosure may accordingly test the chromatic dispersion degree of the image generated after passing through the screen lens and the advantages and disadvantages of the preset preprocessing algorithm, i.e., may realize the testing of the preprocessing result of the preprocessing algorithm.

### Method Embodiment II

With reference to FIG. 2, it shows a step flowchart of a testing method according to a second embodiment of the present disclosure, which may specifically include steps as follows:

step 201, traversing pixel points in the target image and determining whether a current pixel point is a chromatic dispersion pixel point;

step 202, counting the number of chromatic dispersion pixel points in the target image to obtain the number of chromatic dispersion pixel points in the target image;

step 203, determining the ratio of the chromatic dispersion pixel points to the total pixel points of the target image according to the number of the chromatic dispersion pixel points; and

step 204, determining the chromatic dispersion degree of the target image according to the ratio.

In contrast to method embodiment I, the embodiment of the present disclosure subdivides the step of determining the number of chromatic dispersion pixel points in the target image into step 201 and step 202, so that by determining whether each of the pixel points of the target image is a chromatic dispersion pixel point, the chromatic dispersion pixel points in the target image may be then identified and the number of chromatic dispersion pixel points in the target image may be obtained.

In an optional embodiment of the present disclosure, the above described step of determining whether the current pixel point is a chromatic dispersion pixel point may specifically include steps of:

step S1, determining chroma of the current pixel point according to values of red R, green G and blue B of the current pixel point;

step S2, determining whether a difference between the chroma of the current chromatic dispersion pixel point and a target chroma is greater than a first difference threshold: wherein, the target chroma is chroma in the ideal state without chromatic dispersion; and

step S3, determining that the current pixel point is a chromatic dispersion pixel point when the difference between the chroma of the current chromatic dispersion pixel point and the target chroma is greater than the first difference threshold.

In an application example of the present disclosure, it is assumed that the above described first difference threshold is 10° and the pixel point of the target image in the ideal state without chromatic dispersion is red, i.e., the target chroma is 0°; if the determined chroma of the current pixel point is 9° according to the values of red R, green G and blue B of the current pixel point, the difference between the chroma of the current pixel point and the target chroma is 9°, i.e., the difference between the chroma of the current pixel point and the target chroma 0° is smaller than 10°, and it may be determined that the current pixel point is a non-chromatic dispersion pixel point, if the determined chroma of the current pixel point is 19° according to the values of red R, green G and blue B of the current pixel point, the difference between the chroma of the current pixel point and the target chroma is 19°, i.e., the difference between the chroma of the current pixel point and the target chroma 0° is greater than 10°, and it may be determined that the current pixel point is a chromatic dispersion pixel point.

It may be appreciated that, the above described first difference threshold of 10° is only an example of the first difference threshold in the embodiment of the present disclosure, and should not be considered as a limitation of the first difference threshold in the embodiment of the present disclosure, and as a matter of fact, the first difference threshold may also be any other value, for example, 9°, 11°, 13° and the like, and the embodiment of the present disclosure does not specifically limit the first difference threshold.

In an optional embodiment of the present disclosure, the above described step of determining the chroma of the current pixel point according to the values of red R, green G and blue B of the current pixel point may specifically include steps as follows.

Step A1, determining a maximum value and a minimum value among the three values of red R, green G and blue B of the current pixel point.

In the embodiment of the present disclosure, the maximum value and minimum value among the three values of red R, green G and blue B of the current pixel point may be determined by the following equations (2) and (3);

Max=MAX(R,G,B) (2)

Min=MIN(R,G,B) (3)

Wherein, the above Max may represent the maximum value among the three values of red R, green G and blue B of the current pixel point; Min may represent the minimum value among the three values of red R, green G and blue B; MAX (R, G, B) may represent evaluating the maximum value among the three values of red R, green G and blue B; MIN (R, G, B) may represent evaluating the minimum value among the three values of red R, green G and blue B.

Step A2, if the difference between the maximum value and the minimum value is smaller than a second difference threshold, the chroma of the pixel point is 0°.

In an application example of the present disclosure, assuming the above described second difference threshold is 10, if the current pixel point (R, G, B) is pixel point A (220, 220, 220), the maximum value and the minimum value among the three values of red R, green G and blue B are both 220, and the difference between the maximum value and the minimum value is 0, smaller than the second difference threshold 10, and therefore it may be determined that the chroma of the current pixel point is 00; if the current pixel point (R, G, B) is pixel point Q (215, 214, 210), the maximum value and the minimum value among the three values of red R, green G are respectively 215 and 210, and the difference between the maximum value and the minimum value is 5, smaller than the second difference threshold 10, and therefore it may be determined that the chroma of the current pixel point is 0°.

It may be appreciated that, the above described second difference threshold of 10° is only an example of the second difference threshold in the embodiment of the present disclosure, and should not be considered as a limitation of the second difference threshold in the embodiment of the present disclosure, and as a matter of fact, the second difference threshold may also be any other value, for example, 9°, 11°, 13° and the like, and the embodiment of the present disclosure does not specifically limit the second difference threshold.

Step A3, if the maximum value is R and G is greater than or equal to B, the chroma of the pixel point may be determined in a first determination manner.

In an optional embodiment of the present disclosure, the above described step for determining the chroma of the pixel point in the first determination manner may specifically include steps as follows:

step A31, calculating a difference between G and B and the difference between the maximum value and the minimum value

step A32, calculating a first ratio value of a first difference between G and B to a second difference between the maximum value and the minimum value;

step A33, calculating a first product of the first ratio value and 60°;

step A34, determining the first product as the chroma of the pixel point.

In the embodiment of the present disclosure, if the maximum value is R and G is greater than or equal to B, the chroma of the pixel point may be determined using the following equation (4):

$${H}_{1} = 60 ° \times \frac{G - B}{max - min} + 0 ° ; \qquad ( 4 )$$

Wherein, the above H may represent the chroma of the pixel point when the maximum value is R and G is greater than or equal to B.

In an application example of the present disclosure, if the current pixel point (R, G, B) is pixel point W(230, 45, 10), the maximum value and the minimum value among the three values of red R, green G and blue B are respectively R230 and B10, and G45 is greater than or equal to B10, and then the chroma of the above described pixel point W(230, 45, 10) is:

$${H}_{1} = 60 ° \times \frac{45 - 10}{230 - 10} + 0 ° = 9.5 °$$

Step A4, if the maximum value is R and G is smaller than B, the chroma of the pixel point may be determined in a second determination manner.

In an optional embodiment of the present disclosure, the above described step of determining the chroma of the pixel point in a second determination manner may specifically include steps as follows:

step A41, calculating the difference between G and B and the difference between the maximum value and the minimum value;

step A42, calculating a first ratio value of the first difference between G and B to the second difference between the maximum value and the minimum value;

step A43, calculating a first product of the first ratio value and 60°;

step A44, determining a sum of the first product and 360° as the chroma of the pixel point.

In the embodiment of the present disclosure, if the maximum value is R and G is smaller than B, the chroma of the pixel point may be determined using the following equation (5):

$${H}_{2} = 60 ° \times \frac{G - B}{max - min} + 360 ° \qquad ( 5 )$$

Wherein, the above H₂ may represent the chroma of the pixel point when the maximum value is R and G is smaller than B.

In an application example of the present disclosure, if the current pixel point (R, G, B) is pixel point T(230, 10, 45), then the maximum value and the minimum value among the three values of red R, green G and blue B are respectively R230 and G10, and G10 is smaller than B45, and then the chroma of the above described pixel point T(230, 10, 45) is:

$${H}_{2} = 60 ° \times \frac{10 - 45}{230 - 10} + 360 ° = 350.5 °$$

Step A5, if the maximum value is G, the chroma of the pixel point may be determined in a third determination manner.

In an optional embodiment of the present disclosure, the above described step of determining the chroma of the pixel point in the third determination manner may specifically include: step A51, calculating the difference between B and R and the difference between the maximum value and the minimum value; step A52, calculating a second ratio value of a third difference between B and R to a second difference between the maximum value and the minimum value; step A53, calculating a second product of the second ratio value and 60°; and step A54, determining a sum of the second product and 120° as the chroma of the pixel point.

In the embodiment of the present disclosure, if the maximum value is G, the chroma of the pixel point may be determined using the following equation (6):

$$H = 60 ° \times \frac{B - R}{max - min} + 120 ° \qquad ( 6 )$$

Wherein, the above H may represent the chroma of the pixel point when the maximum value is G.

In an application example of the present disclosure, if the current pixel point (R, G, B) is pixel point Y(10, 230, 45), then the maximum value and the minimum value among the three values of red R, green G and blue B are respectively G230 and R10, and then the chroma of the above described pixel point Y(10, 230, 45) is:

$${H}_{3} = 60 ° \times \frac{45 - 10}{230 - 10} + 120 ° = 129.5 ° ;$$

Step A6, if the maximum value is B, the chroma of the pixel point may be determined in a fourth determination manner.

In an optional embodiment of the present disclosure, the above described step of determining the chroma of the pixel point in the fourth determination manner may specifically include steps as follows:

step A61, calculating the difference between R and G and the difference between the maximum value and the minimum value;

step A62, calculating a third ratio value of a fourth difference between R and G to the second difference between the maximum value and the minimum value;

step A63, calculating a third product of the third ratio value and 60°; and

step A64, determining a sum of the third product and 240° as the chroma of the pixel point.

In the embodiment of the present disclosure, if the maximum value is B, the chroma of the pixel point may be determined using the following equation (7):

$${H}_{4} = 60 ° \times \frac{R - G}{max - min} + 240 ° \qquad ( 7 )$$

In an application example of the present disclosure, if the current pixel point (R, G, B) is pixel point Y(10, 45, 230), then the maximum value and the minimum value among the three values of red R, green G and blue B are respectively B230 and R10, and then the chroma of the above described pixel point X(10, 45, 230) is:

$${H}_{4} = 60 ° \times \frac{10 - 45}{230 - 10} + 240 ° = 230.5 °$$

In an optional embodiment of the present disclosure, the above described target image may in particular be a black-and-white checkerboard image. On one hand, since in the ideal state without chromatic dispersion there are only two colors, black and white, in the black-and-white checkerboard image and there is no any other color, it is convenient to observe and find chromatic dispersion pixel points in the image generated after chromatic dispersion occurs to the black-and-white checkerboard image.

On the other hand, since the black-and-white checkerboard image is symmetrical in horizontal and vertical directions, it is easy to observe chromatic dispersion at boarders of the black and white, facilitating following comments and other processing; in the embodiment of the present disclosure, it is recommended that the black grid and the white grid have the same size, both have the shape of a square, and the entire black-and-white checkerboard image is a black-and-white checkerboard image of a square shape.

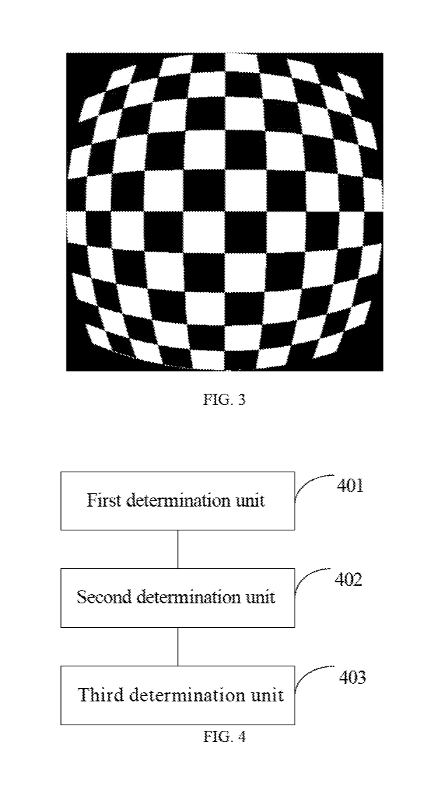

With reference to FIG. 3, it shows a schematic view of a black-and-white checkerboard image generated in a virtual reality helmet after being preprocessed by a preset preprocessing algorithm and passing through a screen lens of the present disclosure.

In the embodiment of the present disclosure, in an ideal state, the obtained image should be a black-and-white checkerboard, i.e., the image contains pixel points only of black and white colors; traversing the pixel points in the black-and-white checkerboard, determining pixel points of colors other than black and white as chromatic dispersion pixel points, counting the number of the chromatic dispersion pixel points and calculating the ratio of the above described chromatic dispersion pixel points to the total pixels of the entire black-and-white checkerboard image, thereby testing the chromatic dispersion degree of the above described black-and-white checkerboard to evaluate the advantages and disadvantages of the above described preset preprocessing algorithm.

It should be noted that, in order to simplify the description, the method embodiments are all described as a series of action combination, but a person skilled in the art should appreciate that, the embodiments of the present disclosure are not limited to the described order of the actions, because according to the embodiments of the present disclosure, some steps may be executed in other orders or simultaneously. Secondly, a person skilled in the art should also appreciate that, the embodiments described in the specification are all preferred embodiments, actions involved may be not necessary for the embodiments of the present disclosure.

### Device Embodiment I

With reference to FIG. 4, it shows a schematic structural diagram of a testing device according to a first embodiment of the present disclosure, which may specifically include: a first determination unit 401, a second determination unit 402 and third determination unit 403.

The above described first determination unit 401 may be configured to determine the number of chromatic dispersion pixel points in a target image; wherein, the target image is an image generated after being output onto a screen by a preset preprocessing algorithm and passing through a lens, and the preset preprocessing algorithm is used for performing preprocessing on an image in a virtual reality helmet.

The second determination unit 402 may be configured to determine a ratio of the chromatic dispersion pixel points to total pixel points of the target image according to the number of the chromatic dispersion pixel points.

The third determination unit 403 may be configured to determine the chromatic dispersion degree of the target image according to the ratio.

### Device Embodiment II

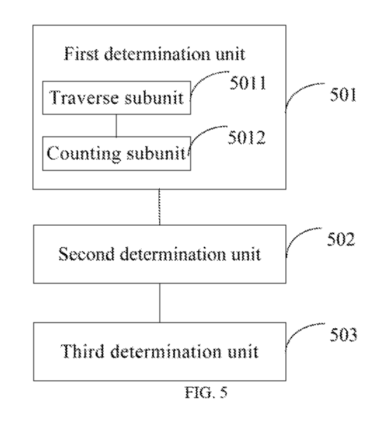

With reference to FIG. 5, it shows a schematic structural diagram of a testing device according to a second embodiment of the present disclosure, which may specifically include: a first determination unit 501, a second determination unit 502 and a third determination unit 503.

The above described first determination unit 501 may be configured to determine the number of chromatic dispersion pixel points in a target image: wherein, the target image is an image generated after being output onto a screen by a preset preprocessing algorithm and passing through a lens, and the preset preprocessing algorithm is used for performing preprocessing on an image in a virtual reality helmet.

The second determination unit 502 may be configured to determine a ratio of the chromatic dispersion pixel points to total pixel points of the target image according to the number of the chromatic dispersion pixel points.

The third determination unit 503 may be configured to determine the chromatic dispersion degree of the target image according to the ratio.

Wherein, the above described first determination unit 501 may specifically include:

a traverse subunit 5011, which may be configured to traverse pixel points in the target image and determine whether a current pixel point is a chromatic dispersion pixel point; and

a counting subunit 5012, which may be configured to count the number of chromatic dispersion pixel points in the target image, to obtain the number of the chromatic dispersion pixel points in the target image.

### Device Embodiment III

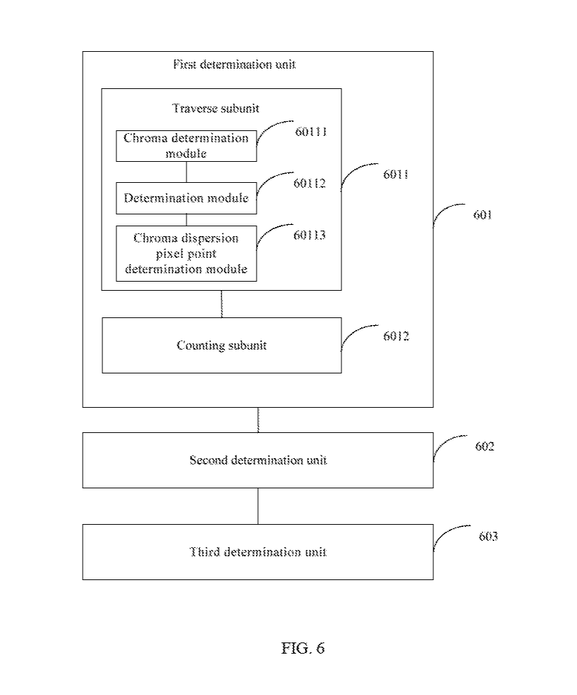

With reference to FIG. 6, it shows a schematic structural diagram of a testing device according to a third embodiment of the present disclosure, which may specifically include: a first determination unit 601, a second determination unit 602 and a third determination unit 603.

The above described first determination unit 601 may be configured to determine the number of chromatic dispersion pixel points in a target image; wherein, the target image is an image generated after being output onto a screen by a preset preprocessing algorithm and passing through a lens, and the preset preprocessing algorithm is used for performing preprocessing on an image in a virtual reality helmet.

The second determination unit 602 may be configured to determine a ratio of the chromatic dispersion pixel points to total pixel points of the target image according to the number of the chromatic dispersion pixel points.

The third determination unit 603 may be configured to determine the chromatic dispersion degree of the target image according to the ratio.

Wherein, the above described first determination unit 601 may specifically include:

a traverse subunit 6011, which may be configured to traverse pixel points in the target image and determine whether the current pixel point is a chromatic dispersion pixel point; and

a counting subunit 6012, which may be configured to count the number of chromatic dispersion pixel points in the target image to obtain the number of the chromatic dispersion pixel points in the target image.

Wherein, the above described traverse subunit 6011 may specifically include:

a chroma determination module 60111, which may be configured to determine the chroma of the current pixel point according to values of red R, green G and blue B of the current pixel point;

a determination module 60112, which may be configured to determine whether a difference between the chroma of the current pixel point and a target chroma is greater than a first difference threshold; wherein, the target chroma is chroma of a pixel point of the target image in an ideal state without chromatic dispersion; and

a chromatic dispersion pixel point determination module 60113, which may be configured to determine the current pixel point as a chromatic dispersion pixel point when the difference between the chroma of the current pixel point and the target chroma is greater than the first difference threshold.

In an optional embodiment of the present disclosure, the above described chroma determination module 60111 may specifically include:

a chroma determination sub-module, which may be configured to determine a maximum value and a minimum value among the three values of red R, green G and blue B of the current pixel point;

a first chroma calculating sub-module, which may be configured to determine the chroma of the pixel point as 0° if a difference between the maximum value and the minimum value is smaller than a second difference threshold;

a second chroma calculating sub-module, which may be configured to determine the chroma of the pixel point in a first determination manner if the maximum value is R and G is greater than or equal to B:

a third chroma calculating sub-module, which may be configured to determine the chroma of the pixel point in a second determination manner if the maximum value is R and G is smaller than B;

a fourth chroma calculating sub-module, which may be configured to determine the chroma of the pixel point in a third determination manner if the maximum value is G; and

a fifth chroma calculating sub-module, which may be configured to determine the chroma of the pixel point in a fourth determination manner if the maximum value is B.

In an optional embodiment of the present disclosure, the above described second chroma calculating sub-module may specifically include:

a first calculating sub-module, which may be configured to calculate the difference between G and B and the difference between the maximum value and the minimum value:

a second calculating sub-module, which may be configured to calculate a first ratio value of a first difference between G and B to a second difference between the maximum value and the minimum value;

a third calculating sub-module, which may be configured to calculate a first product of the first ratio value and 60°; and

a second determination sub-module, which may be configured to determine the first product as the chroma of the pixel point.

In an optional embodiment of the present disclosure, the above described third chroma calculating sub-module may specifically include:

a fourth calculating sub-module, which may be configured to calculate the first ratio value of the first difference between G and B to the second difference between the maximum value and the minimum value;

a fifth calculating sub-module, which may be configured to calculate the first product of the first ratio value and 60°; and

a third determination sub-module, which may be configured to determine the sum of the first product and 360° as the chroma of the pixel point.

In an optional embodiment of the present disclosure, the above described fourth chroma calculating sub-module may specifically include:

a sixth calculating sub-module, which may be configured to calculate a second ratio value of the third difference between B and R to the second difference between the maximum value and the minimum value;

a seventh calculating sub-module, which may be configured to calculate a second product of the second ratio value and 60°; and

a fourth determination sub-module, which may be configured to determine a sum of the second product and 120° as the chroma of the pixel point.

In an optional embodiment of the present disclosure, the above described fifth chroma calculating sub-module may specifically include:

an eighth calculating sub-module, which may be configured to calculate a third ratio value of a fourth difference between R and G to the first difference between the maximum value and the minimum value;

a ninth calculating sub-module, which may be configured to calculate a third product of the third ratio value and 60°; and

a fifth determination sub-module, which may be configured to determine a sum of the third product of and 240° as the chroma of the pixel point.

For device embodiments, since they are basically similar to the method embodiments, the description thereof is relatively simple, and for relative parts please refer to part of the description of the method embodiments.

Device embodiments described above are illustrative only, wherein the unit described as a separate part may be or may be not physically separated, a part displayed as the unit may be or may be not a physical unit, may be located in one place, or may be distributed on a plurality of network units. Some or all of the modules may be selected to achieve the objective of the solutions of the embodiments according to actual requirements. A person skilled in the art may understand and implement it without paying creative works.

Through the above description of embodiments, a person skilled in the art may clearly appreciate that each embodiment may be achieved by means of software with necessary general hardware platform, and of course may also be achieved by hardware. Based on this appreciation, the above described technical solution essentially or the part that makes contribution to the prior art may be embodied in the form of software product, which may be stored in a computer readable storage medium such as ROM/RAM, magnetic disc and optical disc, including several commands configured to cause a piece of computer equipment (which may be a personal computer, a server or a network equipment) to execute the method described in each embodiment or some parts of the embodiments.

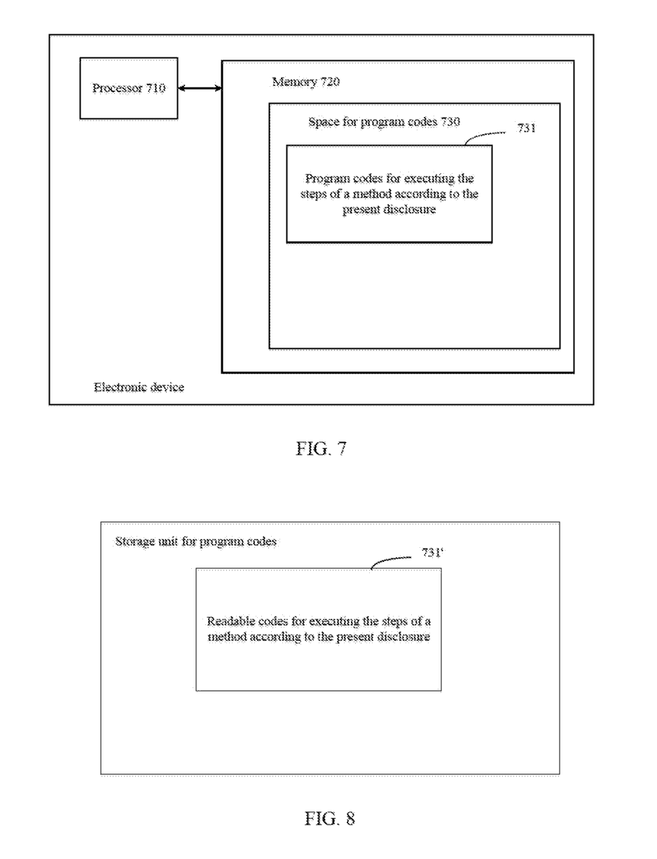

For example, FIG. 7 illustrates a block diagram of an electronic device for executing the method according the disclosure. Traditionally, the electronic device includes a processor 710 and a computer program product or a computer readable medium in form of a memory 720. The memory 720 could be electronic memories such as flash memory, EEPROM (Electrically Erasable Programmable Read-Only Memory), EPROM, hard disk or ROM. The memory 720 has a memory space 730 for executing program codes 731 of any steps in the above methods. For example, the memory space 730 for program codes may include respective program codes 731 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 8. The memory cells may be provided with memory sections, memory spaces, etc., similar to the memory 720 of the server as shown in FIG. 7. The program codes may be compressed for example in an appropriate form. Usually, the memory cell includes computer readable codes 731′ which may be read for example by processors 710. When these codes are operated on the server, the server may execute respective steps in the method as described above.

Finally, it should be noted that the foregoing embodiments are merely illustrative of technical solutions of the present disclosure without limitation; although the present disclosure is illustrated in detail with reference to the above embodiments, a person skilled in the art will appreciate that modifications may be made on the technical solutions cited by the above embodiments, or equivalent substitutions may be made on partial technical features; moreover, these modifications or substitutions will not make the essential of corresponding technical solutions depart from the spirit and scope of the technical solutions in respective embodiments of the present disclosure.

What is claimed is:

1. A testing method, at an electronic device, comprising:
determining the number of chromatic dispersion pixel points in a target image; wherein the target image is an image generated after being output onto a screen by a preset preprocessing algorithm and passing through a lens, and the preset preprocessing algorithm is used for performing preprocessing on an image in a virtual reality helmet;
determining a ratio of the chromatic dispersion pixel points to total pixel points of the target image according to the number of the chromatic dispersion pixel points; and
determining a chromatic dispersion degree of the target image according to the ratio.

2. The method according to claim 1, wherein the step of determining the number of the chromatic dispersion pixel points in the target image comprises:
traversing pixel points in the target image and determining whether a current pixel point is a chromatic dispersion pixel point; and
counting the number of the chromatic dispersion pixel points in the target image, to obtain the number of the chromatic dispersion pixel points in the target image.

3. The method according to claim 2, wherein the step of determining whether the current pixel point is a chromatic dispersion pixel point comprises:
determining chroma of the current pixel point according to values of red R, green G and blue B of the current pixel point;
determining whether a difference between the chroma of the current pixel point and a target chroma is greater than a first difference threshold; wherein the target chroma is chroma of a pixel point of the target image in an ideal state without chromatic dispersion; and
determining the current pixel point as a chromatic dispersion pixel point when the difference between the chroma of the current pixel point and the target chroma is greater than the first difference threshold.

4. The method according to claim 3, wherein the step of determining the chroma of the current pixel point according to the values of red R, green G and blue B of the current pixel point comprises:
determining a maximum value and a minimum value among the three values of red R, green G and blue B of the current pixel point;
determining the chroma of the pixel point as 0° if a difference between the maximum value and the minimum value is smaller than a second difference threshold;
determining the chroma of the pixel point in a first determination manner if the maximum value is R and G is greater than or equal to B;
determining the chroma of the pixel point in a second determination manner if the maximum value is R and G is smaller than B;
determining the chroma of the pixel point in a third determination manner if the maximum value is G; and
determining the chroma of the pixel point in a fourth determination manner if the maximum value is B.

5. The method according to claim 4, wherein the step of determining the chroma of the pixel point in the first determination manner comprises:
calculating a difference between G and B and the difference between the maximum value and the minimum value;
calculating a first ratio value of a first difference between G and B to a second difference between the maximum value and the minimum value;
calculating a first product of the first ratio value and 60°; and
determining the first product as the chroma of the pixel point.

6. The method according to claim 4, wherein the step of determining the chroma of the pixel point in the second determination manner comprises:
calculating a first ratio value of a first difference between G and B to a second difference between the maximum value and the minimum value;
calculating a first product of the first ratio value and 60°; and
determining a sum of the first product and 360° as the chroma of the pixel point.

7. The method according to claim 4, wherein the step of determining the chroma of the pixel point in the third determination manner comprises:
calculating a second ratio value of a third difference between B and R to a second difference between the maximum value and the minimum value;
calculating a second product of the second ratio value and 60°; and
determining a sum of the second product and 120° as the chroma of the pixel point.

8. The method according to claim 4, wherein the step of determining the chroma of the pixel point in the fourth determination manner comprises:
calculating a third ratio value of a fourth difference between R and G to a first difference between the maximum value and the minimum value;
calculating a third product of the third ratio value and 60°; and
determining a sum of the third product and 240° as the chroma of the pixel point.

9. An electronic device for testing, comprising:
at least one processor; and
a memory communicably connected with the at least one processor for storing instructions executable by the at least one processor, wherein execution of the instructions by the at least one processor causes the at least one processor to:
determine the number of chromatic dispersion pixel points in a target image; wherein the target image is an image generated after being output onto a screen by a preset preprocessing algorithm and passing through a lens, and the preset preprocessing algorithm is used for performing preprocessing on an image in a virtual reality helmet;
determine a ratio of the chromatic dispersion pixel points to total pixel points of the target image according to the number of the chromatic dispersion pixel points; and
determine a chromatic dispersion degree of the target image according to the ratio.

10. The electronic device according to claim 9, wherein the step to determine the number of the chromatic dispersion pixel points in the target image comprises:
traverse pixel points in the target image and determine whether a current pixel point is a chromatic dispersion pixel point; and
count the number of the chromatic dispersion pixel points in the target image, to obtain the number of the chromatic dispersion pixel points in the target image.

11. The electronic device according to claim 10, wherein the step to determine whether the current pixel point is a chromatic dispersion pixel point comprises:
determine chroma of the current pixel point according to values of red R, green G and blue B of the current pixel point;
determine whether a difference of the chroma of the current pixel point and a target chroma is greater than a first difference threshold; wherein the target chroma is chroma of a pixel point of the target image in an ideal state without chromatic dispersion; and
determine the current pixel point as a chromatic dispersion pixel point when the difference between the chroma of the current pixel point and the target chroma is greater than the first difference threshold.

12. The electronic device according to claim 11, wherein the step to determine the chroma of the current pixel point according to the values of red R, green G and blue B of the current pixel point comprises:
determine a maximum value and a minimum value among the three values of red R, green G and blue B of the current pixel point;
determine the chroma of the pixel point as 0° if a difference between the maximum value and the minimum value is smaller than a second difference threshold;
determine the chroma of the pixel point in a first determination manner if the maximum value is R and G is greater than or equal to B;
determine the chroma of the pixel point in a second determination manner if the maximum value is R and G is smaller than B;
determine the chroma of the pixel point in a third determination manner if the maximum value is G; and
determine the chroma of the pixel point in a fourth determination manner if the maximum value is B.

13. A non-transitory computer readable medium storing executable instructions that, when executed by an electronic device, cause the electronic device to:
determine the number of chromatic dispersion pixel points in a target image; wherein the target image is an image generated after being output onto a screen by a preset preprocessing algorithm and passing through a lens, and the preset preprocessing algorithm is used for performing preprocessing on an image in a virtual reality helmet;
determine a ratio of the chromatic dispersion pixel points to total pixel points of the target image according to the number of the chromatic dispersion pixel points; and
determine a chromatic dispersion degree of the target image according to the ratio.

14. The non-transitory computer readable medium according to claim 13, wherein the step to determine the number of the chromatic dispersion pixel points in the target image comprises:
traverse pixel points in the target image and determine whether a current pixel point is a chromatic dispersion pixel point; and
count the number of the chromatic dispersion pixel points in the target image, to obtain the number of the chromatic dispersion pixel points in the target image.

15. The non-transitory computer readable medium according to claim 14, wherein the step to determine whether the current pixel point is a chromatic dispersion pixel point comprises:
determine chroma of the current pixel point according to values of red R, green G and blue B of the current pixel point;
determine whether a difference between the chroma of the current pixel point and a target chroma is greater than a first difference threshold; wherein the target chroma is chroma of a pixel point of the target image in an ideal state without chromatic dispersion; and
determine the current pixel point as a chromatic dispersion pixel point when the difference between the chroma of the current pixel point and the target chroma is greater than the first difference threshold.

16. The non-transitory computer readable medium according to claim 15, wherein the step to determine the chroma of the current pixel point according to the values of red R, green G and blue B of the current pixel point comprises:
determine a maximum value and a minimum value among the three values of red R, green G and blue B of the current pixel point;
determine the chroma of the pixel point as 0° if a difference between the maximum value and the minimum value is smaller than a second difference threshold;
determine the chroma of the pixel point in a first determination manner if the maximum value is R and G is greater than or equal to B;
determine the chroma of the pixel point in a second determination manner if the maximum value is R and G is smaller than B;
determine the chroma of the pixel point in a third determination manner if the maximum value is G; and
determine the chroma of the pixel point in a fourth determination manner if the maximum value is B.

17. The non-transitory computer readable medium according to claim 16, wherein the step to determine the chroma of the pixel point in the first determination manner comprises:
calculate a difference between G and B and the difference between the maximum value and the minimum value;
calculate a first ratio value of a first difference between G and B to a second difference between the maximum value and the minimum value;
calculate a first product of the first ratio value and 60°; and
determine the first product as the chroma of the pixel point.

18. The non-transitory computer readable medium according to claim 16, wherein the step to determine the chroma of the pixel point in the second determination manner comprises:
calculate a first ratio value of a first difference between G and B to a second difference between the maximum value and the minimum value;
calculate a first product of the first ratio value and 60°; and
determine a sum of the first product and 360° as the chroma of the pixel point.

19. The non-transitory computer readable medium according to claim 16, wherein the step to determine the chroma of the pixel point in the third determination manner comprises:
calculate a second ratio value of a third difference between B and R to a second difference between the maximum value and the minimum value;
calculate a second product of the second ratio value and 60°; and
determine a sum of the second product and 120° as the chroma of the pixel point.

20. The non-transitory computer readable medium according to claim 16, wherein the step to determine the chroma of the pixel point in the fourth determination manner comprises:
calculate a third ratio value of a fourth difference between R and G to a first difference between the maximum value and the minimum value;
calculate a third product of the third ratio value and 60°; and
determine a sum of the third product and 240° as the chroma of the pixel point.
